(19) United States
(12) Patent Application Publication
(10) Pub. No.: US 2016/0116869 A1
(43) Pub. Date: Apr. 28, 2016

(54) FIXING DEVICE AND IMAGE FORMING APPARATUS

(71) Applicants: Kazuya SAITO, Kanagawa (JP); Ryuuichi MIMBU, Kanagawa (JP); Toshihiko SHIMOKAWA, Kanagawa (JP); Haruyuki HONDA, Kanagawa (JP); Yoshiki YAMAGUCHI, Kanagawa (JP); Yasunori ISHIGAYA, Kanagawa (JP); Yoshio HATTORI, Kanagawa (JP)

(72) Inventors: Kazuya SAITO, Kanagawa (JP); Ryuuichi MIMBU, Kanagawa (JP); Toshihiko SHIMOKAWA, Kanagawa (JP); Haruyuki HONDA, Kanagawa (JP); Yoshiki YAMAGUCHI, Kanagawa (JP); Yasunori ISHIGAYA, Kanagawa (JP); Yoshio HATTORI, Kanagawa (JP)

(21) Appl. No.: 14/852,767

(22) Filed: Sep. 14, 2015

(30) Foreign Application Priority Data
Oct. 23, 2014 (JP) 2014-216119

(51) Int. Cl. G03G 15/20

(52) U.S. Cl. CPC G03G 15/2039

(57) ABSTRACT

A fixing device includes a fixing rotator rotatable in a predetermined direction of rotation and a pressure rotator pressed against the fixing rotator to form a fixing nip therebetween, through which a recording medium bearing a toner image is conveyed. A plurality of heaters heats the fixing rotator. A sensor is disposed opposite the fixing rotator and includes a plurality of temperature detection elements to detect a temperature of the fixing rotator at a plurality of spots thereon arranged in an axial direction of the fixing rotator. A controller is operatively connected to the sensor and the plurality of heaters to control the plurality of heaters based on the temperature of the fixing rotator detected by the sensor and predict a width of the recording medium in the axial direction of the fixing rotator to be conveyed to the fixing nip.

### CROSS-REFERENCE TO RELATED APPLICATION

This patent application is based on and claims priority pursuant to 35 U.S.C. §119 to Japanese Patent Application No. 2014-216119, filed on Oct. 23, 2014, in the Japanese Patent Office, the entire disclosure of which is hereby incorporated by reference herein.

### BACKGROUND

1. Technical Field

Exemplary aspects of the present disclosure relate to a fixing device and an image forming apparatus, and more particularly, to a fixing device for fixing a toner image on a recording medium and an image forming apparatus incorporating the fixing device.

2. Description of the Background

Related-art image forming apparatuses, such as copiers, facsimile machines, printers, or multifunction printers having two or more of copying, printing, scanning, facsimile, plotter, and other functions, typically form an image on a recording medium according to image data. Thus, for example, a charger uniformly charges a surface of a photoconductor; an optical writer emits a light beam onto the charged surface of the photoconductor to form an electrostatic latent image on the photoconductor according to the image data; a developing device supplies toner to the electrostatic latent image formed on the photoconductor to render the electrostatic latent image visible as a toner image; the toner image is directly transferred from the photoconductor onto a recording medium or is indirectly transferred from the photoconductor onto a recording medium via an intermediate transfer belt; finally, a fixing device applies heat and pressure to the recording medium bearing the toner image to fix the toner image on the recording medium, thus forming the image on the recording medium.

Such fixing device may include a fixing rotator, such as a fixing roller, a fixing belt and a fixing film, heated by a heater and a pressure rotator, such as a pressure roller and a pressure belt, pressed against the fixing rotator to form a fixing nip therebetween through which a recording medium bearing a toner image is conveyed. As the recording medium bearing the toner image is conveyed through the fixing nip, the fixing rotator and the pressure rotator apply heat and pressure to the recording medium, melting and fixing the toner image on the recording medium.

### SUMMARY

This specification describes below an improved fixing device. In one exemplary embodiment, the fixing device includes a fixing rotator rotatable in a predetermined direction of rotation and a pressure rotator pressed against the fixing rotator to form a fixing nip therebetween, through which a recording medium bearing a toner image is conveyed. A plurality of heaters heats the fixing rotator. A sensor is disposed opposite the fixing rotator and includes a plurality of temperature detection elements to detect a temperature of the fixing rotator at a plurality of spots thereon arranged in an axial direction of the fixing rotator. A controller is operatively connected to the sensor and the plurality of heaters to control the plurality of heaters based on the temperature of the fixing rotator detected by the sensor and predict a width of the recording medium in the axial direction of the fixing rotator to be conveyed to the fixing nip.

This specification further describes an improved image forming apparatus. In one exemplary embodiment, the image forming apparatus includes an image bearer to bear a toner image and a fixing rotator disposed downstream from the image bearer in a recording medium conveyance direction and being rotatable in a predetermined direction of rotation. A pressure rotator is pressed against the fixing rotator to form a fixing nip therebetween, through which a recording medium bearing the toner image is conveyed. A plurality of heaters heats the fixing rotator. A sensor is disposed opposite the fixing rotator and includes a plurality of temperature detection elements to detect a temperature of the fixing rotator at a plurality of spots thereon arranged in an axial direction of the fixing rotator. A controller is operatively connected to the sensor and the plurality of heaters to control the plurality of heaters based on the temperature of the fixing rotator detected by the sensor and predict a width of the recording medium in the axial direction of the fixing rotator to be conveyed to the fixing nip.

### BRIEF DESCRIPTION OF THE DRAWINGS

A more complete appreciation of the disclosure and the many attendant advantages thereof will be readily obtained as the same becomes better understood by reference to the following detailed description when considered in connection with the accompanying drawings, wherein:

FIG. 1 is a schematic vertical sectional view of an image forming apparatus according to an exemplary embodiment of the present disclosure;

FIG. 2 is a schematic vertical sectional view of a fixing device according to a first exemplary embodiment of the present disclosure, which is installed in the image forming apparatus shown in FIG. 1;

FIG. 3 is a perspective view of a shield plate incorporated in the fixing device shown in FIG. 2;

FIG. 4 is a perspective view of the fixing device shown in FIG. 2 illustrating a sensor incorporated therein;

FIG. 5 is a partial plan view of the fixing device shown in FIG. 2 illustrating a temperature detection span of the sensor shown in FIG. 4;

FIG. 6 is a schematic plan view of the sensor shown in FIG. 4;

FIG. 7 is a plan view of a fixing roller and the sensor incorporated in the fixing device shown in FIG. 2 illustrating the position of the sensor;

FIG. 8 is a diagram of the sensor, the fixing roller, and a heater incorporated in the fixing device shown in FIG. 2 and a temperature distribution of the fixing roller;

FIG. 9 is a circuit diagram of a first example of a circuit configuration of the fixing device shown in FIG. 2;

FIG. 10 is a circuit diagram of a second example of the circuit configuration of the fixing device shown in FIG. 2;

FIG. 11 is a circuit diagram of a third example of the circuit configuration of the fixing device shown in FIG. 2;

FIG. 12 is a lookup table showing an example of a sheet width table stored in a memory incorporated in the fixing device shown in FIG. 2; and

FIG. 13 is a lookup table showing an example of a sheet shift table stored in the memory incorporated in the fixing device according to a second exemplary embodiment of the present disclosure.

### DETAILED DESCRIPTION OF THE DISCLOSURE

In describing exemplary embodiments illustrated in the drawings, specific terminology is employed for the sake of clarity. However, the disclosure of this specification is not intended to be limited to the specific terminology so selected and it is to be understood that each specific element includes all technical equivalents that operate in a similar manner and achieve a similar result.

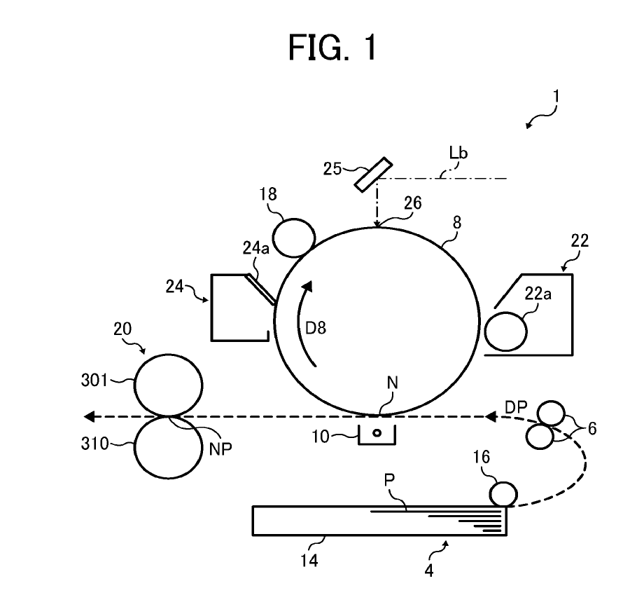

Referring now to the drawings, wherein like reference numerals designate identical or corresponding parts throughout the several views, in particular to FIG. 1, an image forming apparatus 1 according to an exemplary embodiment of the present disclosure is explained.

It is to be noted that, in the drawings for explaining exemplary embodiments of this disclosure, identical reference numerals are assigned, as long as discrimination is possible, to components such as members and component parts having an identical function or shape, thus omitting description thereof once it is provided.

FIG. 1 is a schematic vertical sectional view of the image forming apparatus 1. The image forming apparatus 1 may be a copier, a facsimile machine, a printer, a multifunction peripheral or a multifunction printer (MFP) having at least one of copying, printing, scanning, facsimile, and plotter functions, or the like. According to this exemplary embodiment, the image forming apparatus 1 is a monochrome printer that forms a monochrome toner image on a recording medium by electrophotography. Alternatively, the image forming apparatus 1 may be a color printer that forms a color toner image on a recording medium.

With reference to FIG. 1, a description is provided of a construction of the image forming apparatus 1.

As shown in FIG. 1, the image forming apparatus 1 includes a sheet feeder 4, a registration roller pair 6, a photoconductive drum 8 serving as an image bearer, a transfer device 10, and a fixing device 20.

The sheet feeder 4 includes a paper tray 14 that loads a plurality of sheets P serving as recording media and a feed roller 16 that picks up and separates an uppermost sheet P from other sheets P loaded on the paper tray 14 and feeds the uppermost sheet P to the registration roller pair 6. The registration roller pair 6 temporarily halts the sheet P sent from the feed roller 16 to correct skew of the sheet P and conveys the sheet P to a transfer nip N formed between the photoconductive drum 8 and the transfer device 10 at a time in synchronism with rotation of the photoconductive drum 8, that is, at a time when a leading edge of a toner image formed on the photoconductive drum 8 corresponds to a predetermined position in a leading end of the sheet P in a sheet conveyance direction DP.

The photoconductive drum 8 is surrounded by a charging roller 18 serving as a charger, a mirror 25 constituting a part of an exposure device, a developing device 22 incorporating a developing roller 22a, the transfer device 10, and a cleaner 24 incorporating a cleaning blade 24a, which are arranged in this order clockwise in FIG. 1 in a rotation direction D8 of the photoconductive drum 8.

A light beam Lb reflected by the mirror 25 irradiates and scans the photoconductive drum 8 at an exposure position 26 thereon interposed between the charging roller 18 and the developing device 22 in the rotation direction D8 of the photoconductive drum 8.

A description is provided of an image forming operation to form a toner image on a sheet P that is performed by the image forming apparatus 1 having the construction described above.

As the photoconductive drum 8 starts rotating, the charging roller 18 uniformly charges an outer circumferential surface of the photoconductive drum 8. A light beam Lb emitted by the exposure device irradiates and scans the charged outer circumferential surface of the photoconductive drum 8 at the exposure position 26 thereon according to image data sent from an external device such as a client computer, thus forming an electrostatic latent image on the photoconductive drum 8.

The electrostatic latent image formed on the photoconductive drum 8 moves in accordance with rotation of the photoconductive drum 8 to an opposed position disposed opposite the developing device 22 where the developing device 22 supplies toner to the electrostatic latent image on the photoconductive drum 8, visualizing the electrostatic latent image as a toner image.

As the toner image formed on the photoconductive drum 8 reaches the transfer nip N, the toner image is transferred onto a sheet P conveyed from the paper tray 14 and entering the transfer nip N at a predetermined time by a transfer bias voltage applied by the transfer device 10.

The sheet P bearing the toner image is conveyed to the fixing device 20 that fixes the toner image on the sheet P under heat and pressure. Thereafter, the sheet P bearing the fixed toner image is ejected onto an output tray that stacks the sheet P.

The fixing device 20 includes a fixing roller 301 heated by a heater and in turn heating the sheet P and a pressure roller 310 disposed opposite the fixing roller 301 and pressing the sheet P against the fixing roller 301. As the sheet P is conveyed through a fixing nip NP formed between the fixing roller 301 and the pressure roller 310 pressed against the fixing roller 301, the toner image is fixed on the sheet P under heat and pressure.

As residual toner failed to be transferred onto the sheet P at the transfer nip N and therefore remaining on the photoconductive drum 8 moves under the cleaner 24 in accordance with rotation of the photoconductive drum 8, the cleaning blade 24a scrapes the residual toner off the photoconductive drum 8, thus cleaning the photoconductive drum 8.

Thereafter, a discharger removes residual potential on the photoconductive drum 8, rendering the photoconductive drum 8 to be ready for a next image forming operation.

A description is provided of a construction of the fixing device 20.

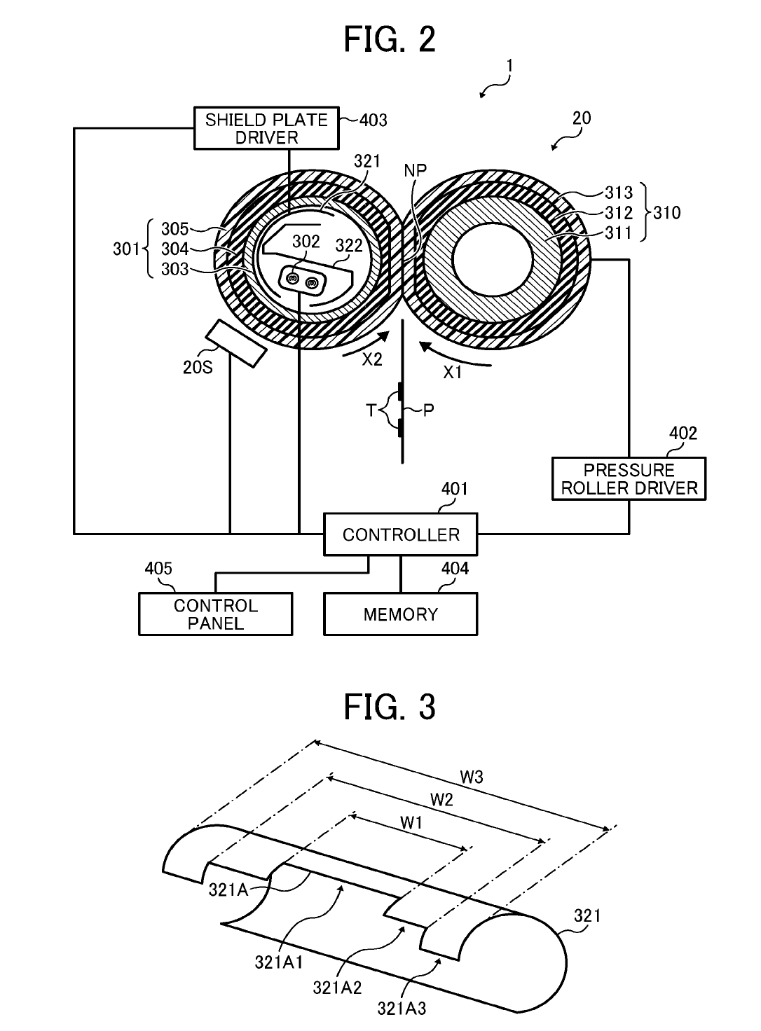

FIG. 2 is a schematic vertical sectional view of the fixing device 20. As shown in FIG. 2, the fixing device 20 (e.g., a fuser or a fusing unit) includes the fixing roller 301 serving as a fixing rotator or a fixing member, a heater 302 serving as a heater or a heat source to heat the fixing roller 301, and the pressure roller 310 serving as a pressure rotator or a pressure member disposed opposite the fixing roller 301.

Inside the fixing roller 301 are a reflector 322 to reflect light from the heater 302 toward the fixing roller 301 and a shield plate 321 serving as a shield to shield the fixing roller 301 from the heater 302 to restrict a heated span on the fixing roller 301 that is heated by the heater 302. The fixing roller 301 is a hollow roller heated by the heater 302, thus heating and melting a toner image T formed on a sheet P. A longitudinal direction of the fixing roller 301 defines an axial direction thereof. A circumferential direction of the fixing roller 301 defines a rotation direction X2 thereof.

The pressure roller 310 is pressed against the fixing roller 301 to form the fixing nip NP between the fixing roller 301 and the pressure roller 310.

The fixing device 20 further includes a sensor 20S disposed opposite the fixing roller 301 to detect the temperature of the fixing roller 301; a shield plate driver 403 serving as a shield driver connected the shield plate 321 to drive and move the shield plate 321; a pressure roller driver 402 connected to the pressure roller 310 to drive and rotate the pressure roller 310; a controller 401 operatively connected to the shield plate driver 403, the sensor 20S, the heater 302, and the pressure roller driver 402 to control them; and a memory 404 operatively connected to the controller 401. Alternatively, the controller 401 and the memory 404 may be located outside the fixing device 20. The controller 401 (e.g., a processor) may include a central processing unit (CPU), a random-access memory (RAM), and a read-only memory (ROM), for example.

According to this exemplary embodiment, the fixing roller 301 is a thin roller elastically deformable. The pressure roller 310 is a roller having a rigidity greater than that of the elastically deformable fixing roller 301. Conversely, the fixing roller 301 may be a rigid roller and the pressure roller 310 may be an elastically deformable hollow roller.

A detailed description is now given of a construction of the fixing roller 301.

The fixing roller 301 is a thin tube rotatable counterclockwise in FIG. 2 in the rotation direction X2. The heater 302 is disposed inside the tubular fixing roller 301. The fixing roller 301 has a multilayer structure constructed of a tubular cored bar 303; an elastic layer 304 coating the cored bar 303; and a release layer 305 coating the elastic layer 304. The fixing roller 301 contacts the pressure roller 310 to form the fixing nip NP.

The cored bar 303 constituting an innermost layer of the fixing roller 301 is made of an iron material such as SUS 304 stainless steel, for example. Alternatively, the cored bar 303 may be made of copper (Cu), nickel (Ni), polyimide (PI), or the like.

For example, the elastic layer 304 is made of an elastic material such as fluoro rubber, silicone rubber, and silicone rubber foam. The elastic layer 304 coating the cored bar 303 facilitates separation of the sheet P ejected from the fixing nip NP and enhances glossiness of a color toner image formed on the sheet P.

The release layer 305 is made of tetrafluoroethylene-perfluoroalkylvinylether copolymer (PFA), polyimide (PI), polyether imide (PEI), polyether sulfide (PES), or the like. The release layer 305 constituting a surface layer of the fixing roller 301 facilitates separation or peeling-off of toner of the toner image T on the sheet P from the fixing roller 301.

A detailed description is now given of a configuration of the heater 302.

The heater 302 serving as a heater or a heat source is located inside the cored bar 303 of the fixing roller 301. For example, the heater 302 is a halogen heater, a laminated heater, or the like. Alternatively, the heater 302 may be an induction heater (IH) disposed opposite an outer circumferential surface of the fixing roller 301 to heat the fixing roller 301 by electromagnetic induction.

A power supply located inside the image forming apparatus 1 depicted in FIG. 1 controls the heater 302 to heat the fixing roller 301. Heat is conducted from the outer circumferential surface of the fixing roller 301 to the unfixed toner image T on the sheet P. Output of the heater 302 is controlled based on the temperature of the outer circumferential surface of the fixing roller 301 detected by the sensor 20S (e.g., a thermopile array) serving as a temperature detector disposed opposite the outer circumferential surface of the fixing roller 301. Thus, the fixing roller 301 is heated to a desired fixing temperature, that is, a target control temperature, by the heater 302 controlled as described above.

A detailed description is now given of a configuration of the reflector 322.

The reflector 322 is mounted on and supported by a stay such that the reflector 322 is disposed opposite the heater 302. Hence, even if the fixing roller 301 rotates, the reflector 322 does not rotate relative to the fixing roller 301. The reflector 322 reflects heat or light radiated from the heater 302 toward the fixing roller 301, suppressing conduction of heat from the heater 302 to the stay and the like and thereby heating the fixing roller 301 effectively and saving energy.

The reflector 322 is made of aluminum, stainless steel, or the like. If the reflector 322 is constructed of an aluminum base treated with vapor deposition of silver having a decreased emissivity and an increased reflectance, the reflector 322 enhances heating efficiency for heating the fixing roller 301.

The shield plate 321 is manufactured by contouring a metal plate having a thickness in a range of from about 0.1 mm to about 1.0 mm into an arch in cross-section along an inner circumferential surface of the fixing roller 301. The shield plate 321 is interposed between the heater 302 and the fixing roller 301 and movable in the circumferential direction of the fixing roller 301.

The fixing roller 301 has a circumferential heated span and a circumferential non-heated span spanning in the circumferential direction thereof. The circumferential heated span is disposed opposite the heater 302 and heated directly by the heater 302. The circumferential non-heated span is disposed opposite components (e.g., the reflector 322 and the stay) interposed between the heater 302 and the fixing roller 301 and mounted on side plates or the like and therefore is not heated by the heater 302 directly. When the shield plate 321 is requested to shield the fixing roller 301 from the heater 302, the controller 401 actuates the shield plate driver 403 to move the shield plate 321 to one or more shield positions situated in the circumferential heated span of the fixing roller 301. Conversely, when the shield plate 321 is not requested to shield the fixing roller 301 from the heater 302, the controller 401 actuates the shield plate driver 403 to move the shield plate 321 to the circumferential non-heated span of the fixing roller 301 so that the entire shield plate 321 is retracted to a retracted position where the shield plate 321 is situated behind the reflector 322 and the stay.

As the shield plate 321 rotates, the shield plate 321 changes the area of the circumferential heated span of the fixing roller 301, adjusting an amount of heat radiated from the heater 302 to the fixing roller 301. Since the shield plate 321 is requested to be heat resistant, the shield plate 321 is made of metal such as aluminum, iron, and stainless steel or ceramic.

A detailed description is now given of a construction of the pressure roller 310.

The pressure roller 310 is constructed of a cored bar 311, an elastic layer 312, and a release layer 313. The cored bar 311 is made of a rigid body. The elastic layer 312 and the release layer 313 may be made of a material similar to the material of the elastic layer 304 and the release layer 305 of the fixing roller 301. A pressurization assembly presses the pressure roller 310 against the fixing roller 301 to form the fixing nip NP between the fixing roller 301 and the pressure roller 310.

A guide plate disposed in proximity to an entry to the fixing nip NP where the fixing roller 301 contacts the pressure roller 310 guides the sheet P to the fixing nip NP.

A description is provided of a construction of a comparative fixing device.

The comparative fixing device includes a fixing roller equivalent to the fixing roller 301 depicted in FIG. 2, a heater to heat the fixing roller, and a plurality of sensors to detect the temperature of the fixing roller. One of the sensors is disposed opposite one lateral end portion of the fixing roller in an axial direction thereof and another one of the sensors is disposed opposite a center portion of the fixing roller in the axial direction thereof. The heater is controlled based on the temperature of the fixing roller detected by the sensors to prevent overheating of the fixing roller.

The plurality of sensors may increase manufacturing costs of the comparative fixing device. Additionally, the sensors may not detect variation in temperature of the fixing roller in the axial direction thereof. Accordingly, it is difficult to control productivity of the comparative fixing device, that is, a number of sheets conveyed through the comparative fixing device per unit time, so as to prevent variation in temperature of the fixing roller.

In order to control productivity of the comparative fixing device to prevent variation in temperature of the fixing roller in the axial direction thereof, it is necessary to detect the size, that is, the width, of the sheet conveyed to the comparative fixing device. It is because the fixing roller is subject to overheating in a non-conveyance span thereon where the sheet is not conveyed that is outboard from a conveyance span where the sheet is conveyed in the axial direction of the fixing roller.

To address this circumstance, a temperature sensor may detect abnormal heating of the fixing roller throughout a heated span on an outer circumferential surface of the fixing roller. If the temperature sensor detects abnormal heating of the fixing roller, a controller may interrupt power supply to the heater.

However, the temperature sensor that detects abnormal heating of the fixing roller is not used to control the temperature of the fixing roller heated by the heater. Accordingly, another temperature sensor directed to control the temperature of the fixing roller may be needed, increasing manufacturing costs.

Further, prediction of the width of the sheet to be conveyed to the comparative fixing device may facilitate temperature control of the fixing roller.

A detailed description is now given of a configuration of the sensor 20S incorporated in the fixing device 20 depicted in FIG. 2.

The controller 401 controls the heater 302, the pressure roller driver 402, and the shield plate driver 403 based on output of the sensor 20S. As the pressure roller driver 402 drives and rotates the pressure roller 310 clockwise in FIG. 2 in a rotation direction X1, the fixing roller 301 contacting the pressure roller 310 rotates in the rotation direction X2 in accordance with rotation of the pressure roller 310.

The sensor 20S is an array temperature sensor having a plurality of temperature detection elements that detects the temperature of a detection object (e.g., the fixing roller 301). For example, the sensor 20S is a thermopile array having a thermopile serving as a temperature detection element that detects the temperature of the detection object without contacting the detection object.

The sensor 20S may further include a shift register that converts a parallel signal as output from the plurality of temperature detection elements into a serial signal and outputs the serial signal. The controller 401 determines the temperature detected by each of the temperature detection elements based on the serial signal received from the sensor 20S.

Preferably, the sensor 20S is a linear thermopile array having a plurality of temperature detection elements arranged linearly. The sensor 20S is installed inside the fixing device 20 such that a longitudinal direction of the linear thermopile array is parallel to a longitudinal direction of the fixing device 20. Thus, the sensor 20S detects the temperature of the fixing roller 301 substantially throughout the entire span of the fixing device 20 in the longitudinal direction thereof, that is, the entire axial span of the fixing roller 301 defined by one lateral end and another lateral end of the fixing roller 301 in the axial direction thereof where the fixing roller 301 heats the sheet P.

Instead of the linear thermopile array, the sensor 20S may be an area thermopile array having a plurality of temperature detection elements arranged rectangularly.

According to this exemplary embodiment, the sensor 20S is a thermopile array positioned relative to the fixing roller 301 such that the sensor 20S detects the temperature of the entire axial span of the fixing roller 301 in the axial direction thereof. Thus, the sensor 20S allows the controller 401 to control the heater 302 to adjust the temperature of the fixing roller 301 and prevent local temperature variation of the fixing roller 301 and resultant degradation in fixing performance.

A description is provided of motion of the shield plate 321.

The controller 401 may control the shield plate driver 403 to move the shield plate 321 to change a shield span based on the temperature of the fixing roller 301 detected by the sensor 20S according to the size of the sheet P and a continuous conveyance time when the sheets P are conveyed through the fixing nip NP or a continuous conveyance number of the sheets P conveyed through the fixing nip NP.

For example, when the sheet P of an A3 size is conveyed through the fixing nip NP, if the temperature of the fixing roller 301 detected by the sensor 20S exceeds a threshold temperature or if the continuous conveyance number of the sheets P exceeds a threshold number, the controller 401 controls the shield plate driver 403 to rotate the shield plate 321 to an A4 size shield position where the shield plate 321 shields an increased axial shield span on the fixing roller 301 from the heater 302.

In this case, the memory 404 stores a table defining the position of the shield plate 321 according to the temperature of the fixing roller 301 detected by the sensor 20S and a table defining the position of the shield plate 321 according to the continuous conveyance number of the sheets P. The controller 401 determines the position of the shield plate 321 by referring to those tables.

FIG. 3 is a perspective view of the shield plate 321. As shown in FIG. 3, the shield plate 321 is substantially tubular and includes a recess 321A in a side face of the shield plate 321. The recess 321A includes a first aperture 321A1 having a first width W1 in a longitudinal direction of the shield plate 321; a second aperture 321A2 having a second width W2 in the longitudinal direction of the shield plate 321 that is greater than the first width W1 of the first aperture 321A1; and a third aperture 321A3 having a full third width W3 in the longitudinal direction of the shield plate 321 that is greater than the second width W2 of the second aperture 321A2.

As the shield plate 321 rotates, the shield plate 321 changes a heated span of the fixing roller 301 heated by the heater 302.

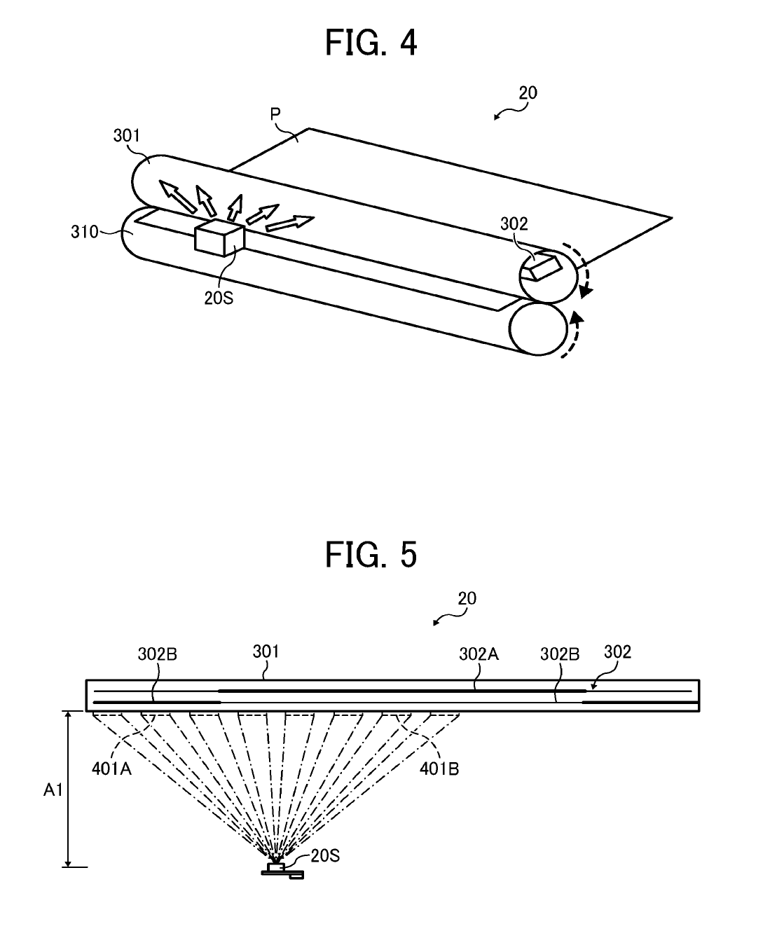

FIG. 4 is a perspective view of the fixing device 20 illustrating the sensor 20S disposed relative to the fixing roller 301. As shown in FIG. 4, the sensor 20S detects the temperature of the fixing roller 301 at a plurality spots thereon, thus obtaining a temperature distribution of the fixing roller 301 in a longitudinal direction thereof parallel to the axial direction. Preferably, the sensor 20S is disposed opposite the fixing roller 301 such that the plurality of temperature detection elements is arranged in parallelism with the axial direction of the fixing roller 301.

If the fixing device 20 incorporates the single sensor 20S, the sensor 20S is disposed outboard from a center of the fixing roller 301 in the axial direction thereof toward one lateral end of the fixing roller 301 in the axial direction thereof.

FIG. 5 is a partial plan view of the fixing device 20 illustrating a temperature detection span of the sensor 20S in the axial direction of the fixing roller 301. As shown in FIG. 5, the heater 302 includes a center heater 302A disposed opposite and heating a center portion of the fixing roller 301 in the axial direction thereof and two lateral end heaters 302B disposed opposite and heating both lateral end portions of the fixing roller 301 in the axial direction thereof, respectively.

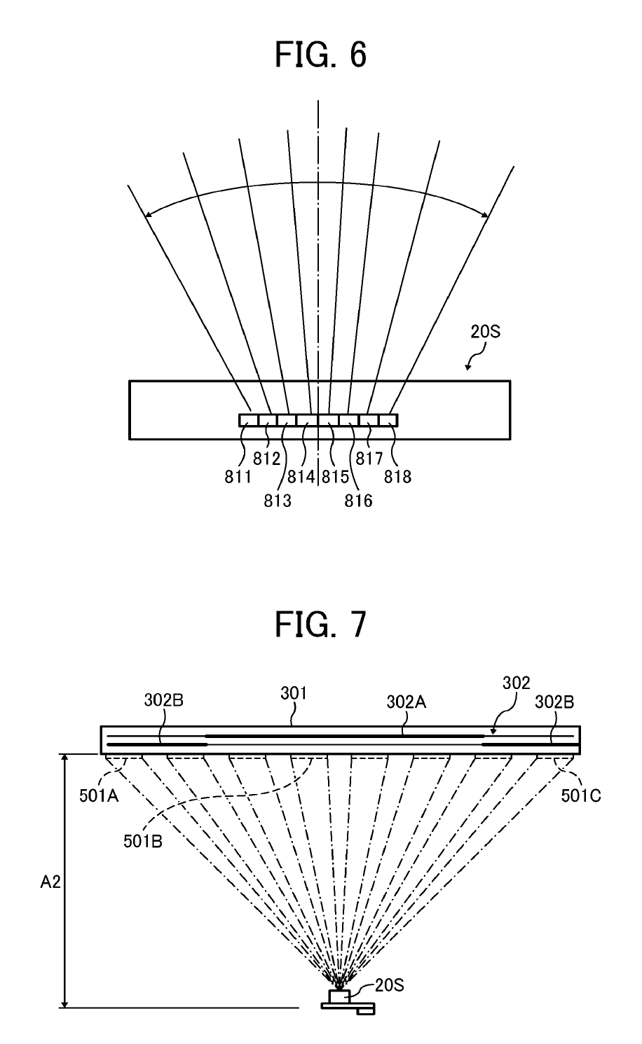

FIG. 6 is a schematic plan view of the sensor 20S. As shown in FIG. 6, the sensor 20S includes eight temperature detection elements 811 to 818 aligned in a longitudinal direction of the sensor 20S parallel to the axial direction of the fixing roller 301. With the sensor 20S disposed outboard from the center of the fixing roller 301 toward one lateral end of the fixing roller 301 in the axial direction thereof, the temperature detection element 812 detects the temperature of a lateral end detection span 401A on the fixing roller 301 shown in FIG. 5 that is disposed opposite one lateral end heater 302B. The temperature detection element 817 detects the temperature of a center detection span 401B on the fixing roller 301 that is disposed opposite the center heater 302A.

Accordingly, the single sensor 20S, not two sensors, detects the temperature of the fixing roller 301 at the lateral end detection span 401A and the center detection span 401B on the fixing roller 301 to control the heater 302.

The controller 401 controls power supply to each of the center heater 302A and the lateral end heaters 302B by feedback of the temperature of the fixing roller 301 detected by the sensor 20S, adjusting an amount of heat conducted to the fixing roller 301 so that the fixing roller 301 is heated to a predetermined target temperature.

FIG. 7 is a plan view of the fixing roller 301 and the sensor 20S illustrating the position of the single sensor 20S to detect the temperature of the fixing roller 301 throughout the entire axial span spanning from one lateral end to another lateral end of the fixing roller 301 in the axial direction thereof. As shown in FIG. 7, in order to allow the single sensor 20S to detect the temperature of the fixing roller 301 throughout the entire axial span spanning from one lateral end to another lateral end of the fixing roller 301 in the axial direction thereof, the sensor 20S is spaced apart from the fixing roller 301 with an increased interval A2 greater than a decreased interval A1 depicted in FIG. 5 between the sensor 20S and the fixing roller 301 in a direction perpendicular to the axial direction of the fixing roller 301. Additionally, the sensor 20S may mount a wide angle lens.

As shown in FIG. 7, the temperature detection element 811 depicted in FIG. 6 detects the temperature of a lateral end detection span 501A on the fixing roller 301 that is disposed opposite one lateral end heater 302B. The temperature detection element 814 depicted in FIG. 6 detects the temperature of a center detection span 501B on the fixing roller 301 that is disposed opposite the center heater 302A. The temperature detection element 818 depicted in FIG. 6 detects the temperature of a lateral end detection span 501C on the fixing roller 301 that is disposed opposite another lateral end heater 302B.

Accordingly, the single sensor 20S, not two sensors, detects the temperature of the fixing roller 301 at both lateral end detection spans 501A and 501C in addition to the center detection span 501B on the fixing roller 301, allowing the controller 401 to control the two lateral end heaters 302B separately.

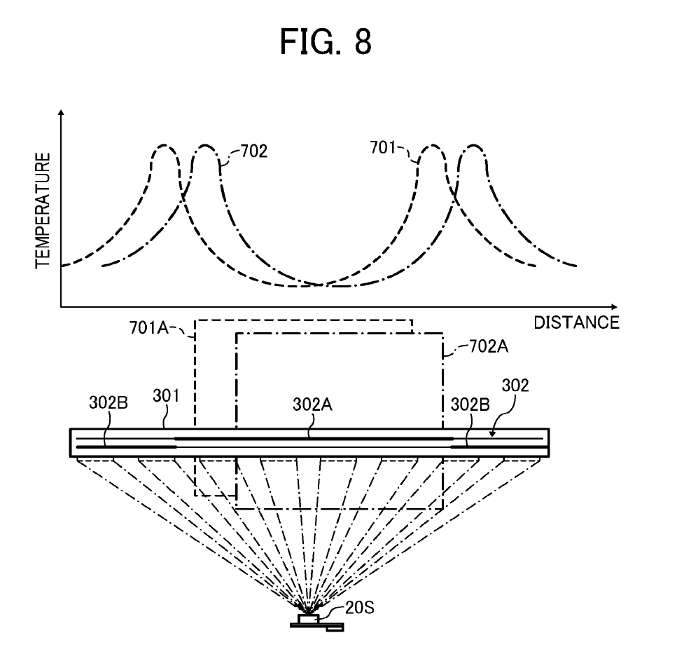

FIG. 8 is a diagram of the sensor 20S, the fixing roller 301, the heater 302, and a temperature distribution of the fixing roller 301 for explaining a detection method for detecting the width of the sheet P and shifting of the sheet P in the axial direction of the fixing roller 301. A vertical axis represents the temperature of the fixing roller 301. A horizontal axis represents the distance from one lateral edge of the fixing roller 301 in the axial direction thereof.

As shown in FIG. 8, while the sheet P is conveyed through the fixing nip NP, the sheet P draws heat from the fixing roller 301, decreasing the temperature of a conveyance span on the fixing roller 301 where the sheet P is conveyed that corresponds to a width of the sheet P. Accordingly, as the sensor 20S detects the decreased temperature of the conveyance span on the fixing roller 301, the controller 401 determines the width of the sheet P.

The conveyance span having the decreased temperature is sandwiched between both non-conveyance spans on the fixing roller 301 in the axial direction thereof that have an increased temperature. The controller 401 detects the number of the temperature detection elements 811 to 818 that detect the decreased temperature of the conveyance span on the fixing roller 301, thus determining the width of the sheet P having been conveyed through the fixing nip NP. Since a plurality of sheets P having an identical size is usually conveyed through the fixing nip NP continuously in a single print job, the controller 401 predicts that a subsequent sheet P has the detected identical width.

If the sheet P is configured to be centered in the axial direction of the fixing roller 301 while the sheet P is conveyed through the fixing nip NP, the sheet P is conveyed over a conveyance span 701A on the fixing roller 301. Accordingly, a temperature distribution of the fixing roller 301 obtained by the sensor 20S draws a curve 701 symmetrical with respect to the center of the fixing roller 301 in the axial direction thereof. Conversely, if the sheet P is shifted rightward in FIG. 8, for example, the sheet P is conveyed over a conveyance span 702A on the fixing roller 301. Accordingly, a temperature distribution of the fixing roller 301 obtained by the sensor 20S draws a curve 702 not symmetrical with respect to the center of the fixing roller 301 in the axial direction thereof and shifted rightward in FIG. 8 compared to the curve 701.

The memory 404 depicted in FIG. 2 prestores the temperature distribution of the fixing roller 301 obtained when the sheet P is centered in the axial direction of the fixing roller 301. The controller 401 compares a temperature distribution of the fixing roller 301 obtained by the sensor 20S with the prestored temperature distribution, determining an amount of shifting or skew of the conveyed sheet P in the axial direction of the fixing roller 301.

A description is provided of a first example of a circuit configuration of the fixing device 20 incorporating the sensor 20S.

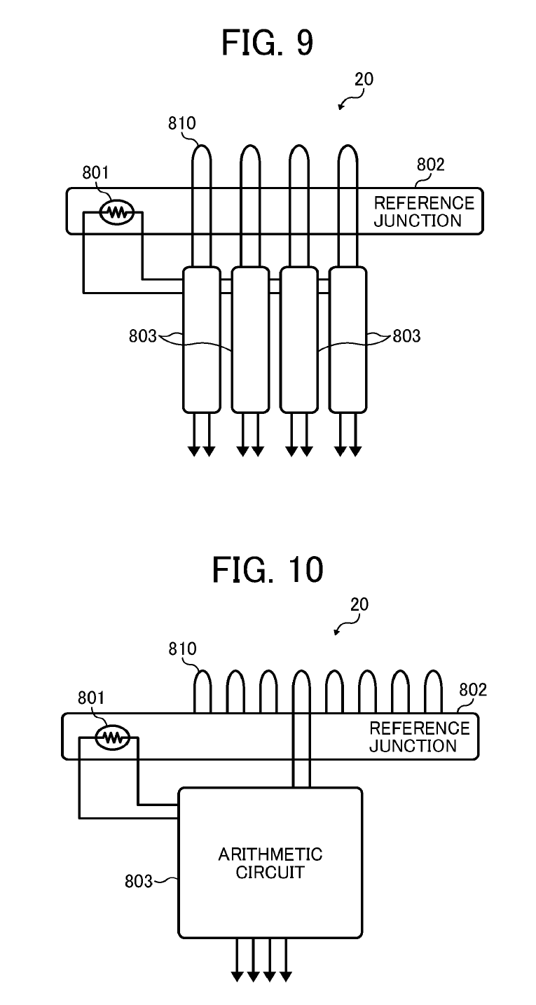

FIG. 9 is a circuit diagram of the first example of the circuit configuration of the fixing device 20.

As shown in FIG. 9, a plurality of temperature detection elements 810 equivalent to the temperature detection elements 811 to 818 depicted in FIG. 6 of the sensor 20S and a reference temperature junction 801 are connected to a reference junction 802. Outputs from the temperature detection elements 810, together with an output from the reference temperature junction 801, enter a plurality of arithmetic circuits 803, respectively, and are subject to processing.

Each of the arithmetic circuits 803 converts an analog signal output from the temperature detection element 810 into a digital signal based on the output from the reference temperature junction 801 and sends the digital signal to the controller 401 depicted in FIG. 2 through a switching circuit.

The switching circuit switches connection of the arithmetic circuits 803 to the controller 401 to connect the arithmetic circuits 803 to the controller 401 in order. Accordingly, the controller 401 receives temperatures of the fixing roller 301 detected by the temperature detection elements 810 one by one in order.

If it takes time to switch connection of the arithmetic circuits 803 to the controller 401, the switching circuit may connect a part of the temperature detection elements 810 to the arithmetic circuits 803. For example, two temperature detection elements 810 may be used.

A description is provided of a second example of a circuit configuration of the fixing device 20 incorporating the sensor 20S.

FIG. 10 is a circuit diagram of the second example of the circuit configuration of the fixing device 20. As shown in FIG. 10, the plurality of temperature detection elements 810 equivalent to the temperature detection elements 811 to 818 depicted in FIG. 6 of the sensor 20S and the reference temperature junction 801 are connected to the reference junction 802. Outputs from the temperature detection elements 810, together with an output from the reference temperature junction 801, enter the single arithmetic circuit 803 and are subject to processing.

The reference junction 802 accommodates the switching circuit that switches connection of the temperature detection elements 810 to the arithmetic circuit 803 in order. Accordingly, the outputs from the temperature detection elements 810 enter the single arithmetic circuit 803 one by one in order.

The arithmetic circuit 803 converts an analog signal output from the temperature detection element 810 into a digital signal based on the output from the reference temperature junction 801 and sends the digital signal to the controller 401.

The second example of the circuit configuration of the fixing device 20 has the single arithmetic circuit 803, reducing manufacturing costs.

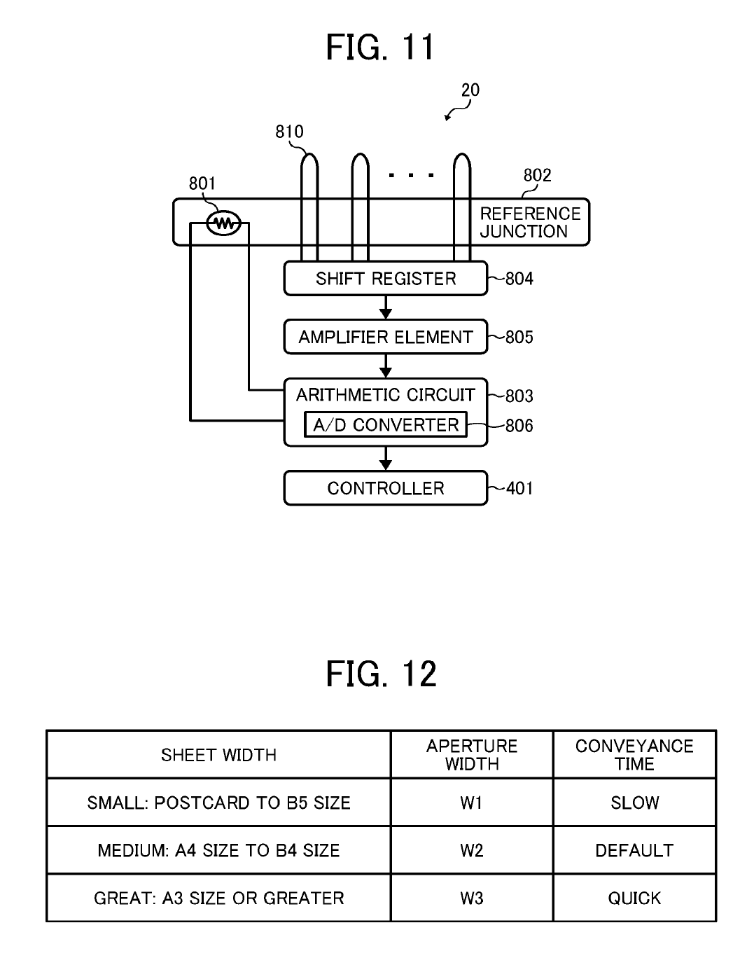

A description is provided of a third example of a circuit configuration of the fixing device 20 incorporating the sensor 20S. FIG. 11 is a circuit diagram of the third example of the circuit configuration of the fixing device 20.

As shown in FIG. 11, the plurality of temperature detection elements 810 equivalent to the temperature detection elements 811 to 818 depicted in FIG. 6 of the sensor 20S and the reference temperature junction 801 are connected to the reference junction 802.

An output signal output from each of the temperature detection elements 810 enters a shift register 804 operatively connected to the temperature detection elements 810 to convert a parallel signal into a serial signal. The shift register 804 converts the parallel signal from the temperature detection element 810 into the serial signal based on an instruction from the controller 401 and sends the serial signal to an amplifier element 805.

The temperature detection elements 810, the shift register 804, and the amplifier element 805 may constitute a single part.

The amplifier element 805 amplifies an input signal and sends the signal to the arithmetic circuit 803. The arithmetic circuit 803 incorporates an analog/digital (A/D) converter 806 that converts an analog signal into a digital signal. The A/D converter 806 converts the input signal into the digital signal and sends the digital signal to the controller 401.

The third example of the circuit configuration of the fixing device 20 achieves a simple circuit configuration that reduces manufacturing costs and eliminates switching, thus saving time.

FIG. 12 is a lookup table showing an example of a sheet width table stored in the memory 404 depicted in FIG. 2. As shown in FIG. 12, the memory 404 depicted in FIG. 2 stores the sheet width table showing a relation among a sheet width of the sheet P, a shield position of the shield plate 321, and a conveyance time to convey the sheet P to the fixing nip NP defined by a conveyance interval between the preceding sheet P and the subsequent sheet P conveyed through the fixing nip NP.

As shown in FIGS. 3 and 12, as a sheet P having a decreased width or a small width (e.g., a postcard to a B5 size sheet) is conveyed through the fixing nip NP, the shield plate 321 moves to a first shield position where the first aperture 321A1 having the decreased first width W1 depicted in FIG. 3 is disposed opposite the heater 302 and the sheets P are conveyed slowly with an increased conveyance interval greater than a default conveyance interval. As a sheet P having a medium width (e.g., an A4 size sheet to a B4 size sheet) is conveyed through the fixing nip NP, the shield plate 321 moves to a second shield position where the second aperture 321A2 having the medium second width W2 is disposed opposite the heater 302 and the sheets P are conveyed at medium speed with the default conveyance interval. As a sheet P having an increased width or a great width (e.g., an A3 size sheet or greater) is conveyed through the fixing nip NP, the shield plate 321 moves to a third shield position where the third aperture 321A3 having the full third width W3 is disposed opposite the heater 302 and the sheets P are conveyed quickly with a decreased conveyance interval smaller than the default conveyance interval.

A description is provided of control processes performed by the fixing device 20.

The controller 401 predicts the width of the sheet P based on output from the sensor 20S. For example, the controller 401 predicts the width of the sheet P based on a difference between a first temperature of the fixing roller 301 detected by a first one of the temperature detection elements 810 (e.g., the temperature detection elements 811 to 818 depicted in FIG. 6) at a first detection spot on the fixing roller 301 and a second temperature of the fixing roller 301 detected by a second one of the temperature detection elements 810 adjacent to the first one thereof at a second detection spot on the fixing roller 301.

The sheets P draw heat from the conveyance span on the fixing roller 301 where the sheets P are conveyed, decreasing the temperature of the conveyance span on the fixing roller 301. Accordingly, the controller 401 compares the first temperature of the first spot on the fixing roller 301 with the second temperature of the second spot on the fixing roller 301 that is adjacent to the first spot in the axial direction of the fixing roller 301. If the difference between the first temperature and the second temperature is not smaller than a threshold, the controller 401 determines that the first spot and the second spot define a lateral edge of the sheet P in the axial direction of the fixing roller 301.

Alternatively, the controller 401 receives temperatures of the fixing roller 301 detected by the temperature detection elements 810 in order. For example, the controller 401 receives temperatures of the fixing roller 301 detected by the temperature detection elements 811 to 818, respectively, in this order from one lateral end to another lateral end of the fixing roller 301 in the axial direction thereof. The controller 401 compares the first temperature of the fixing roller 301 detected by the first one of the temperature detection elements 810 with the second temperature of the fixing roller 301 detected after the first temperature by the second one of the temperature detection elements 810 that is adjacent to the first one of the temperature detection elements 810.

If the second temperature is higher than the first temperature by a threshold temperature or more, the controller 401 reads a third temperature of a third one of the temperature detection elements 810.

If the second temperature is lower than the first temperature by the threshold temperature or more, the controller 401 identifies the temperature detection element 810 that detects a peak temperature that is highest among the temperatures read by the controller 401 and determines that a temperature detection spot on the fixing roller 301 where the identified temperature detection element 810 detects the temperature of the fixing roller 301 contacts one lateral edge of the sheet P in the axial direction of the fixing roller 301. The controller 401 sends the determination to the memory 404.

The controller 401 continues reading the temperatures of the fixing roller 301 detected by the temperature detection elements 810. If the controller 401 detects a subsequent peak temperature, the controller 401 identifies the temperature detection element 810 that detects the peak temperature and determines that a temperature detection spot on the fixing roller 301 where the identified temperature detection element 810 detects the temperature of the fixing roller 301 contacts another lateral edge of the sheet P in the axial direction of the fixing roller 301. The controller 401 sends the determination to the memory 404.

The controller 401 determines the size, that is, the width, of the sheet P based on an interval between the temperature detection element 810 used to determine the one lateral edge of the sheet P and the temperature detection element 810 used to determine the another lateral edge of the sheet Pin the axial direction of the fixing roller 301.

Additionally, the controller 401 may control the conveyance time to convey the sheet P to the fixing device 20.

For example, the controller 401 searches through the sheet width table based on the determined width of the sheet P to retrieve the conveyance time to convey the sheet P to the fixing nip NP of the fixing device 20. The controller 401 changes the conveyance time to convey the sheet P to the fixing device 20 based on the retrieved conveyance time to convey the sheet P to the fixing device 20. The controller 401 performs such change by changing a number of sheets conveyed through the image forming apparatus 1 per unit time for image formation.

As the width of the sheet P decreases, the controller 401 delays the conveyance time to convey the sheet P to the fixing device 20 to increase a time interval between a time when the preceding sheet P is ejected from the fixing nip NP and a time when the subsequent sheet P is conveyed to the fixing device 20. While no sheet P is conveyed through the fixing device 20, the controller 401 turns off the heater 302. In this case, productivity of the image forming apparatus 1 defined by the number of the sheets P conveyed through the fixing device 20 per unit time decreases and a lighting rate per unit time of the heater 302 decreases.

Accordingly, the non-conveyance span on the fixing roller 301 where the sheet P is not conveyed that is outboard from the conveyance span in the axial direction of the fixing roller 301 does not overheat to a temperature higher than a heat resistance temperature of the fixing roller 301.

The controller 401 may change the shield position of the shield plate 321 based on the determined width of the sheet P.

For example, the controller 401 searches through the sheet width table based on the determined width of the sheet P to retrieve the shield position of the shield plate 321. The controller 401 controls the shield plate driver 403 to move the shield plate 321 to the retrieved shield position, thus changing the shield position of the shield plate 321.

As the width of the sheet P decreases, the controller 401 displaces the shield plate 321 to shield the fixing roller 301 from the heater 302 in an increased shield span on the fixing roller 301.

In addition to the control processes described above, the controller 401 controls the plurality of heaters shown in FIGS. 5 and 7, that is, the center heater 302A and the lateral end heaters 302B, to adjust the temperature of the fixing roller 301 heated by the center heater 302A and the lateral end heaters 302B. In this case, the memory 404 stores a heater control table in addition to the sheet width table.

As described above, the fixing device 20 according to this exemplary embodiment includes the sensor 20S including the plurality of temperature detection elements 810 to detect the temperature distribution of the fixing roller 301 in the axial direction thereof. The controller 401 determines the width of the sheet P based on output of the sensor 20S and controls the conveyance time to convey the sheet P to the fixing device 20 based on the determined width of the sheet P, thus adjusting the number of the sheets P conveyed through the fixing device 20 per unit time.

Accordingly, the fixing device 20 prevents fixing failure caused by variation in temperature of the fixing roller 301 effectively while reducing manufacturing costs.

A description is provided of a configuration of the fixing device 20 according to a second exemplary embodiment.

A construction of the fixing device 20 according to the second exemplary embodiment is equivalent to the construction of the fixing device 20 according to the first exemplary embodiment described above. According to the second exemplary embodiment, the memory 404 depicted in FIG. 2 stores a sheet shift table showing a relation among a shift amount of the sheet P from a centered conveyance span of the sheet P centered on the fixing roller 301 in the axial direction thereof, the shield position of the shield plate 321, and the conveyance time to convey the sheet P to the fixing nip NP.

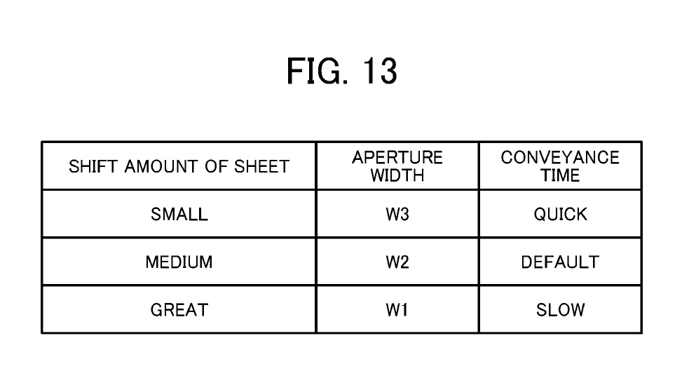

FIG. 13 is a lookup table showing an example of the sheet shift table stored in the memory 404. As shown in FIG. 13, the sheet shift table shows the relation among the shift amount of the sheet P from the centered conveyance span of the sheet P centered on the fixing roller 301 in the axial direction thereof, the shield position of the shield plate 321, and the conveyance time to convey the sheet P to the fixing nip NP, that is, the conveyance interval between the preceding sheet P and the subsequent sheet P conveyed through the fixing nip NP.

As shown in FIG. 13, when the shift amount of the sheet P is small, the shield plate 321 moves to the third shield position where the third aperture 321A3 having the increased third width W3 depicted in FIG. 3 is disposed opposite the heater 302 and the sheets P are conveyed quickly with the decreased conveyance interval smaller than the default conveyance interval. When the shift amount of the sheet P is medium, the shield plate 321 moves to the second shield position where the second aperture 321A2 having the medium second width W2 is disposed opposite the heater 302 and the sheets P are conveyed at medium speed with the default conveyance interval. When the shift amount of the sheet P is great, the shield plate 321 moves to the first shield position where the first aperture 321A1 having the decreased first width W1 is disposed opposite the heater 302 and the sheets P are conveyed slowly with the increased conveyance interval greater than the default conveyance interval.

A description is provided of control processes performed by the fixing device 20 according to the second exemplary embodiment.

The controller 401 predicts the width of the sheet P to be conveyed to the fixing nip NP through control processes similar to the control processes performed by the fixing device 20 according to the first exemplary embodiment described above.

The controller 401 calculates a center of the sheet P in a width direction thereof parallel to the axial direction of the fixing roller 301 based on the predicted width of the sheet P. For example, the controller 401 determines the center of the sheet P in the width direction thereof defined by a center between two spots on the fixing roller 301 that have two peak temperatures, respectively.

The controller 401 determines a distance between the determined center of the sheet P on the fixing roller 301 and a prestored center of the fixing roller 301 in the axial direction thereof as the shift amount of the sheet P.

The controller 401 searches through the sheet shift table based on the determined shift amount of the sheet P to retrieve the conveyance time to convey the sheet P to the fixing device 20. The controller 401 changes the conveyance time to convey the sheet P to the fixing device 20 based on the retrieved conveyance time to convey the sheet P to the fixing device 20. As the shift amount of the sheet P increases, the controller 401 delays the conveyance time to convey the sheet P to the fixing device 20.

If the shift amount of the sheet P exceeds a threshold, the controller 401 issues an alert. For example, the controller 401 causes an input-output device, such as a control panel 405 depicted in FIG. 2 that is disposed atop the image forming apparatus 1 shown in FIG. 1 and operatively connected to the controller 401, to display an alert. The alert may be a message to urge a user to center the sheets P on the paper tray 14 depicted in FIG. 1 by correcting shifting of the sheets P, for example, “Verify that sheets are placed on the paper tray properly.”

The controller 401 may change the shield position of the shield plate 321 based on the determined shift amount of the sheet P.

For example, the controller 401 searches through the sheet shift table based on the determined shift amount of the sheet P to retrieve the shield position of the shield plate 321. The controller 401 controls the shield plate driver 403 to move the shield plate 321 to the retrieved shield position, thus changing the shield position of the shield plate 321.

As the shift amount of the sheet P decreases, the controller 401 displaces the shield plate 321 to shield the fixing roller 301 from the heater 302 in an increased shield span on the fixing roller 301 that corresponds to the width of the sheet P.

In addition to the control processes described above, the controller 401 controls the plurality of heaters shown in FIGS. 5 and 7, that is, the center heater 302A and the lateral end heaters 302B, to adjust the temperature of the fixing roller 301 heated by the center heater 302A and the lateral end heaters 302B. In this case, the memory 404 stores the heater control table in addition to the sheet shift table.

As described above, the fixing device 20 according to this exemplary embodiment includes the sensor 20S including the plurality of temperature detection elements 810 to detect the temperature distribution of the fixing roller 301 in the axial direction thereof. The controller 401 determines the shift amount of the sheet P based on output of the sensor 20S and controls the conveyance time to convey the sheet P to the fixing device 20 based on the determined shift amount of the sheet P, thus adjusting the number of the sheets P conveyed through the fixing device 20 per unit time.

Accordingly, the fixing device 20 prevents fixing failure caused by variation in temperature of the fixing roller 301 effectively while reducing manufacturing costs. Additionally, the fixing device 20 fixes the toner image T on the sheet P effectively at the appropriate time at which the sheet P is conveyed through the fixing device 20.

A description is provided of advantages of the fixing device 20.

As shown in FIG. 2, the fixing device 20 includes a fixing rotator (e.g., the fixing roller 301) rotatable in a predetermined direction of rotation while contacting an unfixed toner image on a recording medium (e.g., a sheet P) and a pressure rotator (e.g., the pressure roller 310) pressed against the fixing rotator to form the fixing nip NP therebetween, through which the recording medium bearing the toner image is conveyed. As shown in FIG. 5, the fixing device 20 further includes a plurality of heaters (e.g., the center heater 302A and the lateral end heaters 302B) disposed opposite the fixing rotator to heat the fixing rotator. As shown in FIGS. 2 and 6, the fixing device 20 further includes a sensor (e.g., the sensor 20S) disposed opposite the fixing rotator. The sensor includes a plurality of temperature detection elements (e.g., the temperature detection elements 811 to 818) to detect a temperature of the fixing rotator at a plurality of spots thereon in an axial direction of the fixing rotator. A controller (e.g., the controller 401) is operatively connected to the sensor and the plurality of heaters to control the plurality of heaters based on the temperature of the fixing rotator detected by the sensor and predict a width of the recording medium in the axial direction of the fixing rotator to be conveyed to the fixing nip NP.

The controller controls the plurality of heaters based on output from the single sensor, predicting the width of the recording medium conveyed to the fixing nip NP while reducing manufacturing costs.

According to the exemplary embodiments described above, the fixing roller 301 serves as a fixing rotator. Alternatively, a fixing belt, a fixing film, a fixing sleeve, or the like may be used as a fixing rotator. Further, the pressure roller 310 serves as a pressure rotator. Alternatively, a pressure belt or the like may be used as a pressure rotator.

The present disclosure has been described above with reference to specific exemplary embodiments. Note that the present disclosure is not limited to the details of the embodiments described above, but various modifications and enhancements are possible without departing from the spirit and scope of the disclosure. It is therefore to be understood that the present disclosure may be practiced otherwise than as specifically described herein. For example, elements and/or features of different illustrative exemplary embodiments may be combined with each other and/or substituted for each other within the scope of the present disclosure.

What is claimed is:

1. A fixing device comprising:
a fixing rotator rotatable in a predetermined direction of rotation;
a pressure rotator pressed against the fixing rotator to form a fixing nip therebetween, through which a recording medium bearing a toner image is conveyed;
a plurality of heaters to heat the fixing rotator;
a sensor disposed opposite the fixing rotator and including a plurality of temperature detection elements to detect a temperature of the fixing rotator at a plurality of spots thereon arranged in an axial direction of the fixing rotator; and
a controller operatively connected to the sensor and the plurality of heaters to control the plurality of heaters based on the temperature of the fixing rotator detected by the sensor and predict a width of the recording medium in the axial direction of the fixing rotator to be conveyed to the fixing nip.

2. The fixing device according to claim 1,
wherein the plurality of temperature detection elements includes:
a first temperature detection element to detect a first temperature of the fixing rotator at a first spot thereon; and
a second temperature detection element to detect a second temperature of the fixing rotator at a second spot thereon that is adjacent to the first spot in the axial direction of the fixing rotator, and
wherein the controller predicts the width of the recording medium based on a difference between the first temperature and the second temperature of the fixing rotator.

3. The fixing device according to claim 1, wherein the controller determines a number of recording media to be conveyed to the fixing nip per unit time based on the predicted width of the recording medium.

4. The fixing device according to claim 1, further comprising:
a shield to shield the fixing rotator from the plurality of heaters; and
a shield driver to move the shield,
wherein the controller is operatively connected to the shield driver to control the shield driver to move the shield based on the predicted width of the recording medium.

5. The fixing device according to claim 4, wherein the shield includes:
a first aperture having a first width in a longitudinal direction of the shield;
a second aperture having a second width in the longitudinal direction of the shield that is greater than the first width of the first aperture; and
a third aperture having a third width in the longitudinal direction of the shield that is greater than the second width of the second aperture.

6. The fixing device according to claim 5, wherein the shield moves to a first shield position where the first aperture is disposed opposite the plurality of heaters as the recording medium having a decreased width is conveyed through the fixing nip.

7. The fixing device according to claim 6, wherein the shield moves to a second shield position where the second aperture is disposed opposite the plurality of heaters as the recording medium having a medium width greater than the decreased width is conveyed through the fixing nip.

8. The fixing device according to claim 7, wherein the shield moves to a third shield position where the third aperture is disposed opposite the plurality of heaters as the recording medium having an increased width greater than the medium width is conveyed through the fixing nip.

9. The fixing device according to claim 1, wherein the controller predicts a shift amount of the recording medium shifted from a centered conveyance span of the recording medium centered on the fixing rotator in the axial direction thereof.

10. The fixing device according to claim 9, wherein the controller determines a number of recording media to be conveyed to the fixing nip per unit time based on the predicted shift amount of the recording medium.

11. The fixing device according to claim 9, further comprising:
a shield to shield the fixing rotator from the plurality of heaters; and
a shield driver to move the shield,
wherein the controller is operatively connected to the shield driver to control the shield driver to move the shield based on the predicted shift amount of the recording medium.

12. The fixing device according to claim 9, wherein if the predicted shift amount of the recording medium exceeds a threshold, the controller outputs an instruction to issue an alert.

13. The fixing device according to claim 1, further comprising an arithmetic circuit operatively connected to the plurality of temperature detection elements to receive outputs therefrom in order.

14. The fixing device according to claim 13, further comprising a shift register operatively connected to the plurality of temperature detection elements to convert a parallel signal from each of the plurality of temperature detection elements into a serial signal.

15. The fixing device according to claim 14, further comprising an amplifier element, operatively connected to the shift register and the arithmetic circuit, to amplify the serial signal received from the shift register and send the amplified signal to the arithmetic circuit.

16. The fixing device according to claim 1, wherein the plurality of heaters includes:
a center heater disposed opposite a center portion of the fixing rotator in the axial direction thereof; and
a lateral end heater disposed opposite a lateral end portion of the fixing rotator in the axial direction thereof.

17. An image forming apparatus comprising:
an image bearer to bear a toner image;
a fixing rotator disposed downstream from the image bearer in a recording medium conveyance direction and being rotatable in a predetermined direction of rotation;
a pressure rotator pressed against the fixing rotator to form a fixing nip therebetween, through which a recording medium bearing the toner image is conveyed;
a plurality of heaters to heat the fixing rotator;
a sensor disposed opposite the fixing rotator and including a plurality of temperature detection elements to detect a temperature of the fixing rotator at a plurality of spots thereon arranged in an axial direction of the fixing rotator; and
a controller operatively connected to the sensor and the plurality of heaters to control the plurality of heaters based on the temperature of the fixing rotator detected by the sensor and predict a width of the recording medium in the axial direction of the fixing rotator to be conveyed to the fixing nip.

18. The image forming apparatus according to claim 17, wherein the controller predicts a shift amount of the recording medium shifted from a centered conveyance span of the recording medium centered on the fixing rotator in the axial direction thereof.

19. The image forming apparatus according to claim 18, further comprising a control panel operatively connected to the controller,
wherein if the predicted shift amount of the recording medium exceeds a threshold, the controller instructs the control panel to display an alert.
